(19) United States
(12) Patent Application Publication
(10) Pub. No.: US 2009/0316298 A1
(43) Pub. Date: Dec. 24, 2009

(54) MAGNETIC DISK DEVICE AND HEAD SLIDER

(75) Inventor: Junichi Ichihara, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/143,530

(22) Filed: Jun. 20, 2008

(51) Int. Cl. G11B 5/52

(52) U.S. Cl. 360/86

(57) ABSTRACT

A head slider suppresses variation in a floating amount of the head slider, floating over a discrete medium, even when the floating amount is small. Among a plurality of pads of the head slider, the shape of the pad provided on the outflow end portion is formed of a wedge shape having a width narrowing toward the air outflow end. Thus, the pressure distribution can be improved, and the air pressure can be averaged. Accordingly, it becomes possible to suppress the variation in the floating amount caused by the discrete medium groove, enabling stable floatation. Moreover, because the stable floatation with a small floating amount can be attained, high-density recording/reproduction can be achieved with accuracy.

### CROSS-REFERENCE TO RELATED APPLICATIONS

This application is based upon and claims the benefit of priority from the prior Japanese Patent Application No. 2007-066252, filed on Mar. 15, 2007, the entire contents of which are incorporated herein by reference.

### BACKGROUND OF THE INVENTION

1. Field of the Invention

The present invention relates to a magnetic disk device and a head slider for reading/writing data from/to data on a track of a magnetic disk by a magnetic head, which is floated over a rotating magnetic disk, and more particularly, a magnetic disk device and a head slider for stabilizing a floating amount of the magnetic disk formed of a discrete medium.

2. Description of the Related Art

In order to improve the recording density of the magnetic disk in recent years, a discrete medium having physically uneven formed on the magnetic disk surface for separating tracks is being developed.

FIG. 11 shows an elevation view of a discrete medium. FIG. 12 shows an explanation diagram of the conventional head slider. Also, FIG. 13 shows an explanation diagram of an air bearing surface of the conventional head slider.

As shown in FIG. 11, a medium 10 having discrete tracks includes a data zone 12 for recording and reproducing normal information and a servo zone 11 having pre-recorded servo information for head positioning, etc., in a mixed manner.

Because of a difference of a function, the surface shapes, such as the groove shapes, of the two zones processed on the surface of medium 10 are differently formed. The data zone 12 has each groove 12a processed along the circumferential direction, to separate each track 12b. The servo zone 11 has a width B, and includes servo information recording areas 11b, each being separated by each groove 11a formed in the radial direction of the medium.

The servo information includes a Gray code (indicating a track number), a preamble for timing control, etc., and position information, which are recorded in each servo information recording area 11b separated by the groove 11a. For each track formed in the circumferential direction of medium 10, the servo information is formed in an identical position when viewed in the radial direction of the medium. Therefore, in the servo zone 11, the groove 11a is formed in the radial direction, to prevent interference of servo information.

As such, since the surface structure of medium 10 differs between two zones 11 and 12, the fluid resistance on the surface of medium 10 differs in each zone 11 and 12. Therefore, a floating amount of a floating head slider mounted head for information recording/reproduction, varies between when the head slider is floating over the servo zone 11 and when the head slider is floating over the data zone 12.

As shown in FIG. 12, a head slider 20 faces opposite to the surface of medium 10, and floats by a fluid air pressure caused by the movement of medium 10. With the improved recording density in recent years, the floating amount is on the order of 10 nanometers. On the side face of the head slider 20, an electromagnetic conversion element (read/write element) 24 is provided. In FIG. 12, the left end of the head slider 20 is a fluid air inflow end, and the right end thereof is an outflow end.

The head slider 20 not only floats the electromagnetic conversion element 24 above medium 10, but controls a floating posture also. For this purpose, as shown in FIG. 13, a front pad 21 having a relatively large area is provided on the inflow end side, and also, a rear pad 23 having a size equal to a width Wh of the electromagnetic conversion element 24 is provided on the outflow end side.

Due to the area difference between the front pad 21 and the rear pad 23, the slider 20 floats in such a manner that the outflow end side (the electromagnetic conversion element 24 side) approaches the medium 10 nearer than the inflow end side. In other words, the floating gap becomes minimum at a far outflow end edge E. Between the front pad 21 and the rear pad 23, a pair of middle pads 22 is provided in the vicinity of both the upper and lower ends of a bearing surface, so as to control the posture of slider 20 in the track transversal direction.

FIG. 12 shows a cross-sectional view of the rear pad 23 shown in FIG. 13. The rear pad 23 formed of a two-layered film is provided on the slider base 20. In FIG. 12, the layer structure thereof is shown stepwise.

FIG. 14 shows exemplary measurement the floating amount when head slider 20 is floated over medium 10 having such the non-uniform surface groove structure as illustrated in FIGS. 11 and 12. Here, the depth of the groove formed on the surface of medium 10 is 15 nm (nanometers) uniformly. In FIG. 14, the horizontal axis indicates the time (movement position), and the vertical axis indicates the floating amount. As can be observed in FIG. 14, the floating amount of head slider 20, originally having approximately 10 nm, abruptly varies by approximately 5 nm.

The above phenomenon is caused by a variation of a pressure generated due to a variation of the fluid resistance produced on the surface of the servo zone 11, when the pad 23 on the far outflow end portion of the head slider 20 passes over the servo zone 11. When such a large variation is produced in the floating amount, there occurs a variation of the signal level in the reproduction signal of electromagnetic conversion element 24, causing inconvenience such that information reproduction becomes impossible, or accurate information recording becomes impossible.

To prevent such the phenomenon, conventionally, it has been proposed to prevent the variation in the floating amount in the servo zone 11 by making the length L of the slider 20 longer than the width B of the servo zone 11 (for example, refer to Patent document 1).

Also, in the other prior art, it has been proposed to prevent the variation in the floating amount by optimizing the ratio between the total pad area of the head slider 20 to the total area of a convex portion of medium 10 positioned exactly below the pad (for example, refer to Patent document 2).

[Patent document 1] Japanese Unexamined Patent Publication No. Hei-5-81808.

[Patent document 2] Japanese Unexamined Patent Publication No. 2005-50482.

However, according to the first prior art, when a large floating amount is allowed, the method is effective in reducing the width of variation relative to the large floating amount, whereas when a floating amount is small, a relative variation width becomes large, and therefore, it is difficult to suppress variation in the floating amount.

Further, according to the second prior art also, as shown in FIG. 5 of Patent document 1, when the floating amount is relatively large, such as 20 nm, the method is effective in relatively decreasing the variation width, whereas when the floating amount is small (for example, 10 nm), the relative variation width becomes large, and it is difficult to suppress variation in the floating amount.

### SUMMARY OF THE INVENTION

Accordingly, it is an object of the present invention to provide a magnetic disk device and a head slider for suppressing variation in a floating amount, at the time of passing over the servo zone of a discrete medium.

It is another object of the present invention to provide a magnetic disk device and a head slider for achieving accurate recording/reproduction, by suppressing variation in a floating amount at the time of passing over the servo zone of a discrete medium.

It is still another object of the present invention to provide a magnetic disk device and a head slider for achieving high-density recording/reproduction, by suppressing variation in a floating amount from a discrete medium, even when the floating amount is small.

It is still another object of the present invention to provide a magnetic disk device and a head slider for achieving an optimal floating amount for high-density perpendicular magnetic recording, by suppressing variation in a floating amount.

In order to achieve the aforementioned objects, a magnetic disk device according to the present invention includes: a magnetic disk including a data zone and a servo zone, and having grooves on a surface; a spindle motor for rotating the magnetic disk; an actuator for driving an arm to the radial direction of the magnetic disk; and a head slider, including a magnetic head, provided on the tip of the arm. The above head slider includes the magnetic head provided on the outflow end side, and a bearing surface having a plurality of pads. Further, among the plurality of pads, a pad shape provided on the outflow end portion is formed of a wedge shape having a width narrowing toward the outflow end.

Further, a head slider according to the present invention for floating over a magnetic disk having a data zone and a servo zone and having grooves on the surface, includes: a magnetic head provided on an outflow end side; and a bearing surface having a plurality of pads. Further, among the plurality of pads, a pad shape provided on the outflow end portion is formed of a wedge shape having a width narrowing toward the outflow end.

Still further, according to the present invention, preferably, a length of the pad wedge shape provided on the outflow end portion is longer than the maximum width of the servo zone of the magnetic disk.

Further, according to the present invention, preferably, the apex angle of the pad wedge shape provided on the outflow end portion is no greater than 90 degrees.

Further, according to the present invention, preferably, the pad provided on the outflow end portion is formed of at least two layers, and a surface layer out of the two layers is formed of a wedge shape.

Further, according to the present invention, preferably, the pad provided on the outflow end portion includes a surface layer formed of a wedge shape, and a head forming layer provided underneath the surface layer to form the magnetic head.

Further, according to the present invention, preferably, the head forming layer has a width for forming the magnetic head on the outflow end, and other portions than the outflow end are formed of the surface layer shape.

Further, according to the present invention, preferably, the pad wedge shape provided on the outflow end portion has an apex.

Further, according to the present invention, preferably, the pad wedge shape provided on the outflow end portion has a straight portion at the outflow end.

Further, according to the present invention, preferably, the magnetic disk includes the data zone having a plurality of tracks, separated by grooves, along the circumference direction of the magnetic disk, and a servo zone being separated by grooves and provided in the radial direction of the magnetic disk.

Further, according to the present invention, preferably, the head slider includes a front pad provided on the inflow end, and a rear pad provided on the outflow end.

Further scopes and features of the present invention will become more apparent by the following description of the embodiments with the accompanied drawings.

### BRIEF DESCRIPTION OF THE DRAWINGS

FIG. 1 shows a structural diagram of one embodiment of a magnetic disk device according to the present invention.

FIG. 2 shows an explanation diagram of a bearing surface of the head slider shown in FIG. 1.

FIG. 3 shows a cross-sectional view of the rear pad shown in FIG. 2.

FIG. 4 shows a pressure distribution diagram of the conventional head slider.

FIG. 5 shows an enlarged view of the rear pad shown in FIG. 2.

FIG. 6 shows a characteristic diagram of variation in a floating amount of the head slider shown in FIG. 2.

FIG. 7 shows a pressure distribution diagram of the head slider shown in FIG. 2.

FIG. 8 shows a relational diagram between the apex angle of rear pad shown in FIG. 2 and variation in floating amount.

FIG. 9 shows a structural diagram of a head slider according to a second embodiment of the present invention.

FIG. 10 shows a structural diagram of a deformed example of a head slider in the second embodiment of the present invention.

FIG. 11 shows a structural diagram of a discrete medium.

FIG. 12 shows an explanation diagram of the conventional head slider.

FIG. 13 shows an explanation diagram of the bearing surface of the conventional head slider.

FIG. 14 shows a characteristic diagram of the floating amount of the conventional head slider.

### DETAILED DESCRIPTION OF THE PREFERRED EMBODIMENTS

The preferred embodiments of the present invention are described hereinafter, in order of a magnetic disk device, a first embodiment of a magnetic head slider, a second embodiment of the magnetic head slider, and other embodiments. However, it is noted that the scope of the present invention is not limited to the embodiments described below.

### Magnetic Disk Device

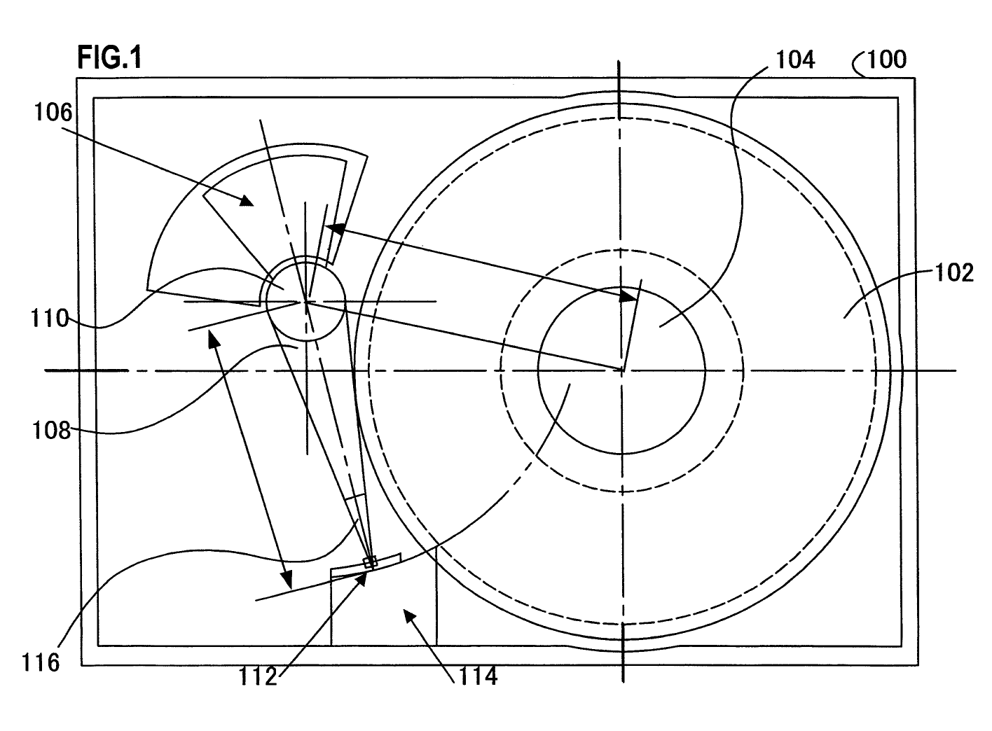

FIG. 1 shows a structural diagram of one embodiment of the magnetic disk device according to the present invention, exemplifying the magnetic disk device of a perpendicular recording type. As shown in FIG. 1, a magnetic disk 102 which is a perpendicular magnetic recording medium, is provided on a rotating shaft 104 of a spindle motor. The spindle motor rotates the rotating shaft 104, so as to rotate magnetic disk 102. An arm 108 is rotated around a rotating shaft 110 by means of a VCM (voice coil motor) 106. A suspension 116 is mounted at the tip of the arm 108.

At the tip of the suspension 116, there is provided a head slider 112 having a magnetic head (read element and write element) mounted thereon. Also, there is provided a ramp load mechanism 114 for retracting the magnetic head from the magnetic disk 102, so as to park. The above mechanisms are housed inside a device cabinet 100.

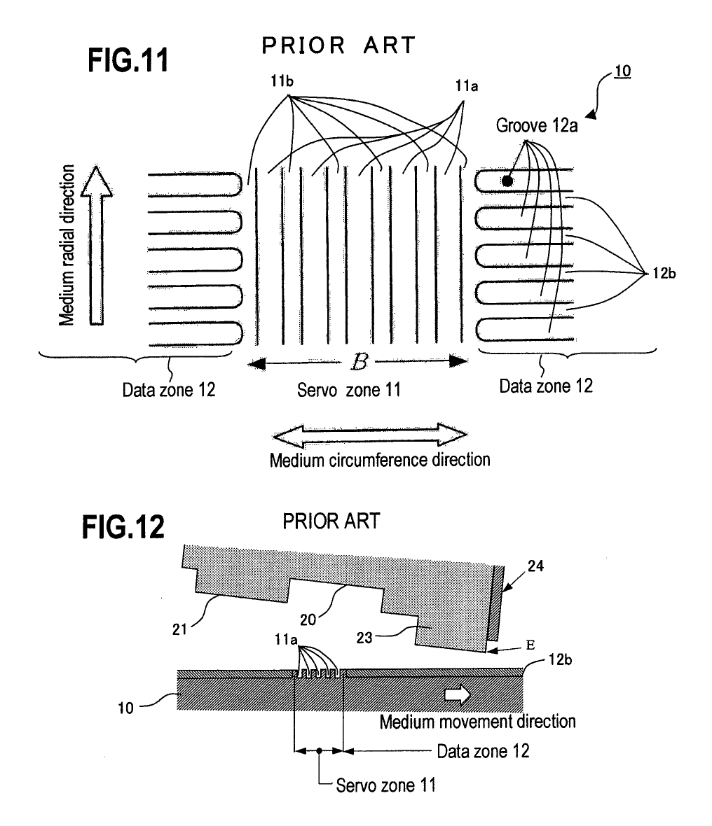

The above magnetic disk 102 is formed of a discrete medium having been explained in FIGS. 11 and 12. Further, in the magnetic disk device, the arm 108 is rotated by VCM 106 in the radial direction of the magnetic disk 102, so as to position the head slider 112, including the magnetic head, at a desired track of the magnetic disk 102.

As described in FIGS. 11 and 12, a plurality of tracks, which are separated by grooves, are formed on concentric circles. And as magnetic disk 102 rotates, the magnetic head performs data reading and writing in an arbitrary sector of a track circle.

The magnetic head includes a read element and a write (perpendicular recording) element. More specifically, the magnetic head is formed of a read element including a magnetic resistance (MR) element, which is laminated on the head slider, and also a write element including a write coil, laminated on the read element.

### First Embodiment of Head Slider

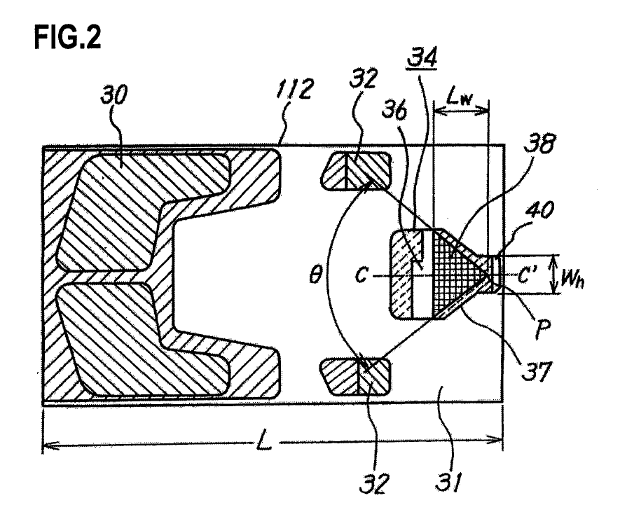

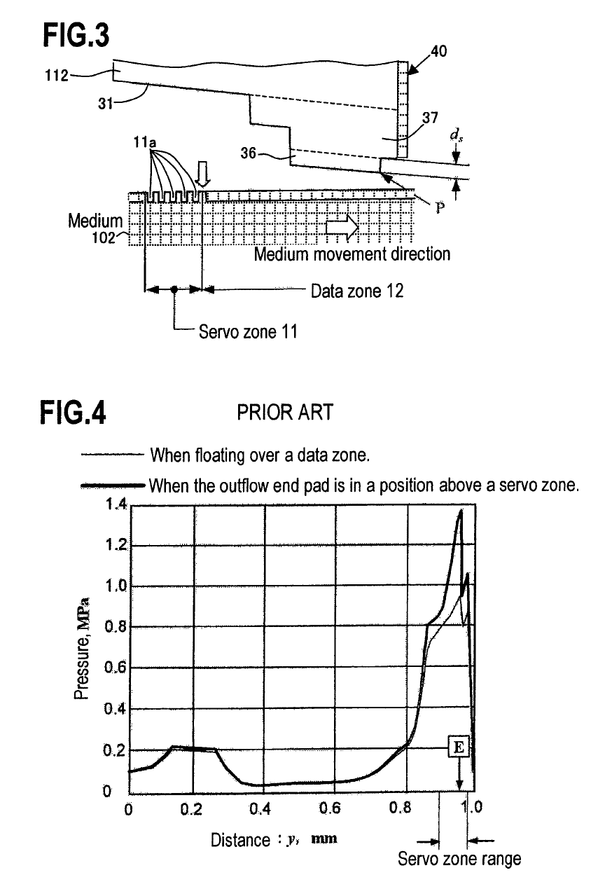

FIG. 2 shows a diagram illustrating the shape of a bearing surface of the head slider, according to the first embodiment of the present invention; FIG. 3 shows the cross-sectional view thereof; and FIG. 4 shows a pressure distribution diagram of the conventional head slider.

As shown in FIG. 2, the head slider 112 provides a front pad 30 having a relatively large area on the inflow end side, and on the outflow end side, a rear pad 34 having a size equal to a width Wh of an electromagnetic conversion element (magnetic head) 40. As shown in FIG. 3, due to the difference in area between front the pad 30 and the rear pad 34, the slider 112 floats so that the outflow end side (electromagnetic conversion element 40 side) approaches the medium 102 more than the inflow end side. In other words, the floating gap becomes minimum at a far outflow end edge P.

In this example, between the front pad 30 and the rear pad 34, a pair of middle pads 32 is provided in the vicinity of both the upper and lower ends of a bearing surface, so as to control the posture of the slider 112 in the track transversal direction.

As shown in FIG. 2 and FIG. 3, the rear pad 34, which is a far outflow end pad, includes a head forming layer 37 and a surface layer 36 provided on the head forming layer 37. The surface layer 36 has a wedge shape of which width gradually narrows toward the outflow end. The apex angle of the wedge is shown by θ.

As shown by the cross section shape along the slider center line CC′ of the far outflow end pad 34 shown in FIG. 3, the layer 37 for forming a head is provided with a step difference ds=2 nm from the surface layer 36 of the far outflow end pad. This layer 37 also has a narrowing structure toward the outflow end.

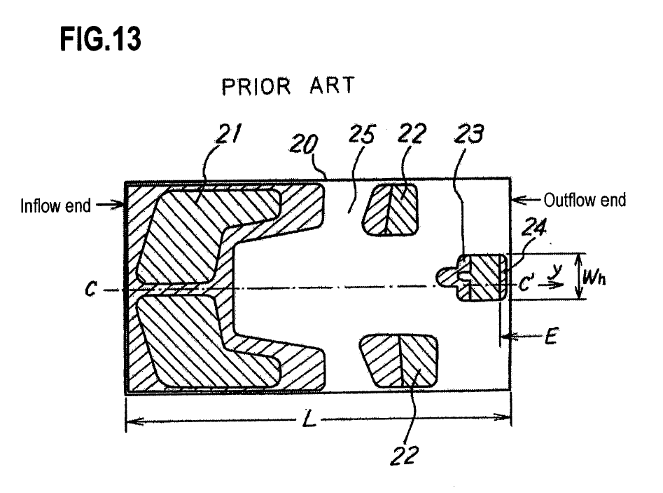

However, on the far outflow end portion of head forming layer 37, a width Wh for forming the head is secured. As such, by forming the surface layer 36 of the far outflow end pad 34 into a wedge shape, in the present embodiment, the floating gap becomes minimum at the apex P of the wedge-shaped portion. As contrasted with the conventional example shown in FIG. 13, the floating gap becomes minimum at the far outflow end edge E having a linear shape.

Also, the length Lw of portion 38 forming the wedge shape of surface layer 36 is set to be larger than the maximum value of the width B of the servo zone 11 on the medium 102.

The reason for forming the wedge-shaped portion on the rear pad 34 is described below. FIG. 4 shows the calculation result of pressure distribution along the center line CC′ of the conventional head slider shown in FIG. 13. The horizontal axis indicates a position (distance) y from the slider inflow end as a criterion, and the vertical axis indicates a pressure.

In FIG. 4, a thin line indicates the pressure distribution when the slider 20 shown in FIG. 13 is floating over a data zone, and a bold line indicates the pressure distribution when the far outflow end edge E is in a position above a servo zone. Also, in the figure, a portion illustrated as servo zone range corresponds to the servo zone.

In both cases, conventionally, a great pressure is produced on the far outflow end pad portion 23 of the slider 20. Also, on the more upstream side than the far outflow end edge E (inflow end side), air is compressed, and the pressure rises accordingly. Whereas on the downstream (outflow end) side, the gap becomes large, and the air is abruptly expanded, and the pressure is decreased accordingly. Therefore, the pressure has a peak value on the far outflow end edge E.

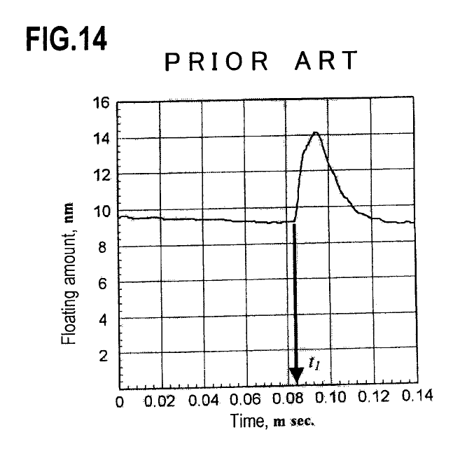

Also, when the far outflow end edge E is in a position above servo zone 11, a greater pressure is produced, as compared with the case when the far outflow end edge E is positioned above the data zone 12. As a result, at the time the far outflow end edge E moves from the data zone to the servo zone, the floating amount increases. In FIG. 14, a time point t1 at which the floating amount starts varying abruptly is a time point in which the far outflow end edge E of the head slider 20 coincides with the boundary between the data zone 12 and the servo zone 11 (shown by the downward arrow in FIG. 3). Also, the far outflow end edge E requires a certain extent of width Wh for forming the head 24, and if the above width is great, also the variation in the floating amount becomes large.

Namely, the pad in the far outflow end portion influences the pressure at the far outflow end edge E. Therefore, it is intended to suppress the variation in the floating amount by appropriately forming the shape of pad 34 in the far outflow end portion.

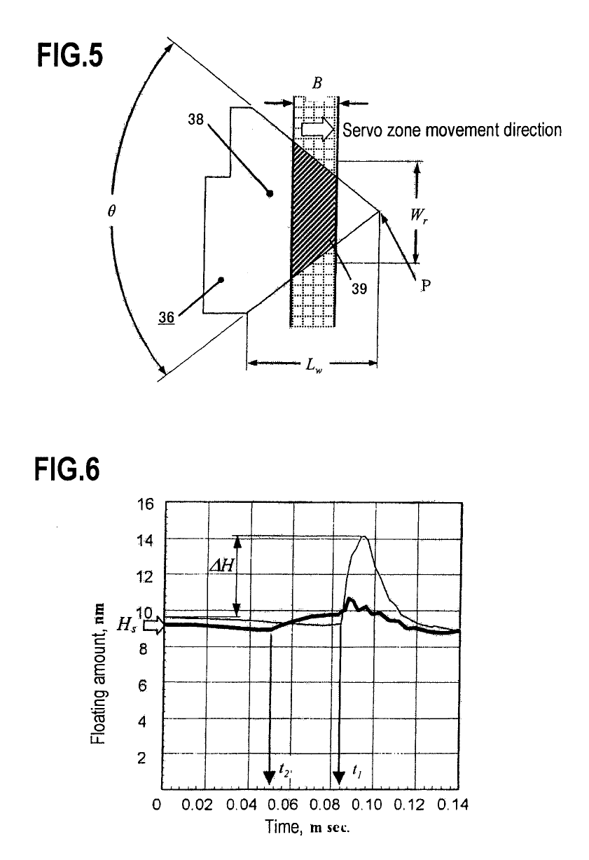

FIG. 5 shows status that the servo zone 11 moves below wedge-shaped portion 38 on the surface layer 36 of the far outflow end pad 34 of the head slider 112. An area 39 (oblique line portion in the figure) in which the wedge-shaped portion 38 overlaps with the servo zone 11 is a trapezoid, as shown in the figure.

When the far outflow end pad 36 passes over the servo zone 11, the pressure in this portion rises. When the pad surface layer 36 is formed of the wedge shape 38, the effect of high-pressure air flowing out to the side face side of the wedge-shaped portion 38 becomes increased. In particular, as the trapezoid portion approaches the apex P of wedge-shaped portion 38, the above effect becomes greater. Accordingly, in contrast to the conventional case that the influence of passing over the servo zone appears to the pressure of the far outflow end edge E in concentration, the pressure distribution according to the present embodiment becomes improved and mitigated.

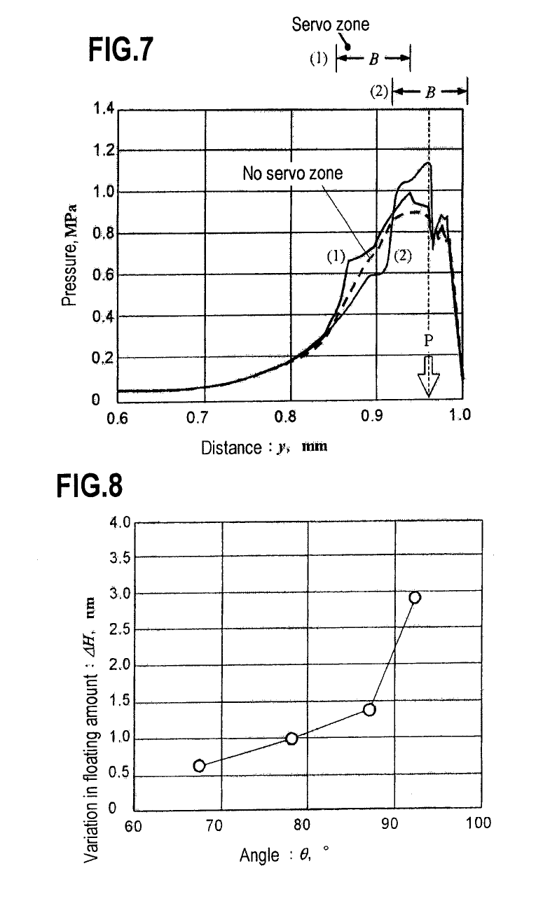

FIG. 7 shows the calculation result of pressure distribution along a slider center line CC according to the present embodiment, which is illustrated by expanding the vicinity of the far outflow end pad portion 34. Three pressure distribution types are shown. In FIG. 7, the horizontal axis indicates the position (distance) on the slider, and the vertical axis indicates the pressure. FIG. 7 shows the pressure distribution corresponding to the relative positional relationship between the servo zone and the slider. The dotted line shows the pressure distribution when the slider 112 is not passing over the servo zone. Also, the black bold line (shown by (1)) corresponds to a case when the servo zone 11 is positioned on the inflow end side of wedge-shaped portion 38 of the far outflow end pad 34 (namely, the apex P of the wedge-shaped portion 38 is positioned outside servo zone 11), whereas the thin line (shown by (2)) corresponds to a case when the apex P of the wedge-shaped portion 38 of the slider coincides with the center of servo zone 11.

When the above FIG. 7 is compared with the prior FIG. 4 (conventional case), in the case of FIG. 4, there is a remarkable difference in the pressure magnitude particularly at the outflow end portion, depending on the positional relationship between the far outflow end edge E and servo zone 11. On the other hand, in the case of FIG. 7, no great difference is recognized in the pressure magnitude depending on the positional relationship between the servo zone 11 and the slider 112.

As such, by forming the far outflow end pad surface 36 into the wedge shape 38, the influence of the far outflow end pad 34 passing over the servo zone 11 can be reduced.

Secondly, in the present embodiment, a force generated at the far outflow end pad portion is adjusted. As shown in FIG. 5, when overlap area 39 is positioned in the nearer portion to the outflow end of pad 38, the floating gap is small on average. As a result, although the generated pressure becomes great, an average value of the width Wr of the overlap area 39 is small.

In contrast, when the overlap area 39 is positioned on the inflow end side, the gap is large and the generated pressure is small. However, the width Wr of the overlap area is large. Therefore, the force generated in overlap area 39 [=area {Wr×(servo pattern width)}×pressure] has no large difference between when the overlap area 39 is positioned at the inflow end side and when the overlap area 39 is positioned at the outflow end side. Namely, the relative difference between the generated forces is small, irrespective of the relative positional relationship.

In the conventional head slider shown in FIG. 13, before and after the position in which the servo zone 11 coincides with the outflow end edge E, the generated force is varied abruptly and greatly, and thereby an abrupt variation is produced in the floating amount. However, in the head slider according to the present embodiment shown in FIG. 2, the generated force is not greatly varied even when the servo zone 11 passes below the wedge-shaped portion 38 and reaches near under the outflow end point P, due to the effect of the wedge shape. Therefore, no abrupt floating variation is produced.

FIG. 6 shows characteristic diagrams of the head slider floating amount according to the present embodiment (FIG. 2) and the prior art (FIG. 13), which are obtained by calculation. The bold line indicates the variation in the floating amount when the head slider of the present embodiment passes over the servo zone 11 of the medium 102. Also, the thin line indicates the variation in the floating amount when the conventional head slider (FIG. 13) passes over the servo pattern.

As shown in FIG. 6, in the head slider 112 according to the present embodiment, a normal value of the floating amount (Hs) becomes approximately 9.2 nm, which is slightly different from 9.4 nm in the case of the conventional head slider shown in FIG. 13, partly because of a different bearing surface shape. However, it can be understood that the variation in the floating amount definitely becomes small, as compared to the case of the conventional head slider.

According to the present embodiment, similar to the conventional case, the floating amount tends to increase from the time point t1 when the boundary between servo zone 11 and data zone 12 reaches the far outflow end point P of the wedge-shaped portion 38 on the surface layer 36 of the far outflow end pad 34. The width of variation thereof becomes remarkably smaller, as compared with the conventional ΔH.

As such, in the present embodiment, main factors of enabling suppression of the floating amount variation at the time of passing over the servo zone are the effects of both the improved pressure distribution by the side face and the adjusted force generated at the far outflow end pad portion, as described above.

As shown in FIG. 6, the floating amount gradually increases from a time point t2 earlier than the time point t1 when the far outflow end point P coincides with the boundary between the data zone 12 and the servo zone 11. The above phenomenon is brought about from the effect of the wedge shape, that is, when the servo zone 11 is positioned nearer the inflow end side of wedge-shaped portion 38, a relatively large force is generated in the overlap area 39 between the wedge-shaped portion 38 and the servo zone 11. In consequence, the floating amount has been varied.

Thus, according to the head slider shown in the present embodiment, the variation in the floating amount produced when the servo zone 11 passes below the far outflow end pad portion 36 is averaged, and it becomes possible to suppress the peak value of the variation in floating.

From the foregoing description, it is apparent that the above-mentioned effect by the shape of surface layer 36 of the far outflow end pad 34 is enhanced by a longer length Lw of wedge-shaped portion 38 than the maximum servo zone width B.

Further, in order that the above effect is sufficiently shown, desirably, the apex angle θ (refer to FIG. 2) of the wedge-shaped portion 38 is an acute angle. FIG. 8 is the calculation result of a floating amount variation peak value ΔH (the difference between a maximum floating amount and an ordinary floating amount shown in FIG. 6) at the time of passing over the servo zone, in reference to the apex angle θ of the wedge-shaped portion.

From FIG. 8, in the head slider according to the present embodiment, when the apex angle θ is set to be 78 degrees, it is understood that the floating amount variation peak value ΔH becomes 1 nm, being suppressed to a sufficiently small value. Also, when the apex angle θ exceeds 90 degrees, it is understood the floating amount variation peak value ΔH increases abruptly. Therefore, desirably, the apex angle of wedge-shaped portion 38 is 90 degrees or less.

Also, in the present embodiment, with regard to layer 37 for forming the head, it is effective to continue applying the same wedge shape as pad surface layer 36 to the possible extent, as shown in FIG. 2. Actually, the step difference between layer 37 forming the head and pad surface layer 36 is on the order of 2 nm, and it is possible to exhibit a greater effect if layer 37 is also formed of a shape resembling the wedge shape.

### Second Embodiment of Magnetic Head Slider

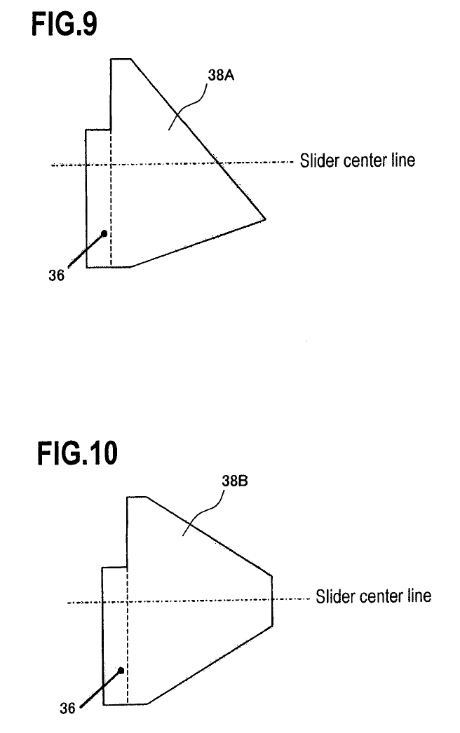

FIG. 9 and FIG. 10 show explanation diagrams of a magnetic head slider according to a second embodiment of the present invention. In these figures, each shape of only pad surface layer 36 of the far outflow end portion is shown. In the first embodiment shown in FIG. 2, wedge-shaped portion 38 symmetrical to the center line of head slider 112 has been shown.

However, the effect is never lost even when the portion 38 is formed of an asymmetrical wedge shape 38A, as shown in FIG. 9, depending on design conditions. Further, similarly, it is possible to form a trapezoidal wedge 38B having a short side on the outflow end side, as shown in FIG. 10. Here, although it is undeniable that the effect in the case shown in FIG. 10 is reduced as compared with the wedge shape case, it is possible to greatly suppress the variation in the floating amount, as compared with the prior art.

### Other Embodiments

According to the above-mentioned embodiments, a magnetic disk device has been described by exemplifying a perpendicular magnetic disk device. However, the present invention is also applicable to other disk device types such as a horizontal magnetic recording device and an optically assisted perpendicular magnetic disk device. Also, as described above, when the rear pad is formed of a trapezoidal shape, the rear pad may be formed of a single layer. Further, the discrete medium is not limited to the structure shown in FIG. 11, and the present invention is applicable to discrete media having other structures. In addition, the present invention is applicable to a structure without any middle pad.

To summarize, according to the present invention, because the pad shape on the outflow end portion in the plurality of head slider pads is formed of a wedge shape having a width narrowing toward the outflow end, the pressure distribution can be improved, and the pressure by the fluid air can be averaged.

Accordingly, it becomes possible to suppress the variation in the floating amount caused by the discrete medium groove, enabling stable floatation. Moreover, because the stable floatation with a small floating amount can be attained, high-density recording/reproduction can be achieved with accuracy.

In the above description, the present invention is explained by the embodiments thereof. However, a variety of deformation may be possible within the effect of the present invention, and the description is not intended to exclude such the deformation from the scope of the present invention.

What is claimed is:

1. A magnetic disk device comprising:
a magnetic disk including a data zone and a servo zone, and having grooves on a surface;
a spindle motor for rotating the magnetic disk;
an actuator for driving an arm to the radial direction of the magnetic disk; and
a head slider, including a magnetic head, provided on a tip of the arm,
wherein the head slider comprises:
a magnetic head provided on an outflow end side; and
a bearing surface having a plurality of pads including a pad provided on the outflow end portion in which a shape of the pad is formed of a wedge shape having a width narrowing toward an outflow end.

2. The magnetic disk device according to claim 1,
wherein a length of the wedge shape of the pad provided on the outflow end portion is longer than a maximum width of the servo zone of the magnetic disk.

3. The magnetic disk device according to claim 1,
wherein an apex angle of the wedge shape of the pad provided on the outflow end portion is no greater than 90 degrees.

4. The magnetic disk device according to claim 1,
wherein the pad provided on the outflow end portion is formed of at least two layers, and a surface layer out of the two layers is formed of a wedge shape.

5. The magnetic disk device according to claim 1,
wherein the pad provided on the outflow end portion comprises:
a surface layer formed of a wedge shape; and
a head forming layer provided underneath the surface layer to form the magnetic head.

6. The magnetic disk device according to claim 5,
wherein the head forming layer has a width for forming the magnetic head on the outflow end, and other portions than the outflow end are formed of the surface layer shape.

7. The magnetic disk device according to claim 1,
wherein the wedge shape of the pad provided on the outflow end portion has an apex.

8. The magnetic disk device according to claim 1,
wherein the wedge shape of the pad provided on the outflow end portion has a straight portion at the outflow end.

9. The magnetic disk device according to claim 1,
wherein the magnetic disk comprises:
the data zone having a plurality of tracks, separated by grooves, along the circumference direction of the magnetic disk; and
the servo zone being separated by another grooves and provided in the radial direction of the magnetic disk.

10. The magnetic disk device according to claim 1,
wherein the head slider comprises:
a front pad provided on the inflow end; and
a rear pad provided on the outflow end.

11. A head slider floating over a magnetic disk which has a data zone and a servo zone and having grooves on a surface, comprising:
a magnetic head provided on an outflow end side; and
a bearing surface having a plurality of pads,
wherein, among the plurality of pads, a pad shape provided on the outflow end portion is formed of a wedge shape having a width narrowing toward the outflow end.

12. The head slider according to claim 11,
wherein a length of the wedge shape of the pad provided on the outflow end portion is longer than the maximum width of the servo zone of the magnetic disk.

13. The head slider according to claim 11,
wherein the apex angle of the wedge shape of the pad provided on the outflow end portion is no greater than 90 degrees.

14. The head slider according to claim 11,
wherein the pad provided on the outflow end portion is formed of at least two layers, and a surface layer out of the two layers is formed of a wedge shape.

15. The head slider according to claim 11,
wherein the pad provided on the outflow end portion comprises:
a surface layer formed of a wedge shape; and
a head forming layer provided underneath the surface layer to form the magnetic head.

16. The head slider according to claim 15,
wherein the head forming layer has a width for forming the magnetic head on the outflow end, and other portions than the far outflow end are formed of the surface layer shape.

17. The head slider according to claim 11,
wherein the pad wedge shape provided on the outflow end portion has an apex.

18. The head slider according to claim 11,
wherein the pad wedge shape provided on the outflow end portion has a straight portion at the outflow end.

19. The head slider according to claim 11,
wherein the magnetic disk comprises:
the data zone having a plurality of tracks, separated by grooves, along the circumference direction of the magnetic disk; and
the servo zone being separated by another grooves and provided in the radial direction of the magnetic disk.

20. The head slider according to claim 11, further comprising:
a front pad provided on the inflow end; and
a rear pad provided on the outflow end.
